(19) United States
(12) Patent Application Publication
(10) Pub. No.: US 2024/0319673 A1
(43) Pub. Date: Sep. 26, 2024

(54) DISPLAY MECHANISM FOR A TIMEPIECE

(71) Applicant: MANUFACTURE D'HORLOGERIE AUDEMARS PIGUET SA, Le Brassus (CH)

(72) Inventor: Eric MAGNIN-FEYSOT, Montlebon (FR)

(21) Appl. No.: 18/578,601

(22) PCT Filed: Jun. 23, 2022
(86) PCT No.: PCT/EP2022/067207

§ 371 Date: Jan. 11, 2024

(30) Foreign Application Priority Data
Jul. 15, 2021 (CH) 070064/2021

(51) Int. Cl. G04B 19/243; G04B 19/20; G04B 33/08

(52) U.S. Cl. CPC G04B 19/24393; G04B 19/205; G04B 33/08

(57) ABSTRACT

A display mechanism for a timepiece movement includes a plate defining a general plane, the display mechanism including a support intended to be rigidly connected to the plate and including a bearing housing a pivot defining an axis of rotation and rigidly connected to a display member bearing at least one display surface intended to be rotated between at least first and second different positions about the axis of rotation and to be situated substantially in a plane parallel to the general plane in the first position so as to define a reading position, in which the conditions for reading by a user are optimal, the support being arranged so that the axis of rotation defined by the pivot is oriented so as to have an inclination of between 10 and 80 degrees with reference to the general plane.

### CROSS-REFERENCE TO RELATED APPLICATIONS

This application is the US national stage of PCT/EP2022/067207, filed Jun. 23, 2022 and designating the United States, which claims the priority of CH 070064/2021, filed Jul. 15, 2021. The entire contents of each foregoing application are incorporated herein by reference.

### TECHNICAL FIELD

The present invention relates to a display mechanism for a timepiece movement comprising a plate defining a general plane, the display mechanism comprising a support intended to be assembled at least indirectly on the plate and on which is rotatably mounted a display member bearing at least one display surface bearing at least one item of information to be displayed associated with a predefined instant or a predefined event, the display surface being intended to be rotated between at least first and second different positions about the axis of rotation of the display member, the support being arranged so that the axis of rotation of the display member is oriented so as to have an inclination of between 10 and 80 degrees with reference to the general plane.

### PRIOR ART

Timepieces are known that comprise a date display mechanism of the large date type comprising two discs sometimes arranged coaxially, and generally pivoted directly on the plate of the corresponding timepiece movement or on an additional plate. These mechanisms make it possible in particular to reduce the footprint of the date display in a plane parallel to the general plane of the corresponding timepiece movement, without however reducing the dimensions of the digits borne by the display discs. FIG. 1a illustrates such a display applied to an alternative quantity, used here by way of non-limiting illustration. The display mechanism in FIG. 1a is intended to display the par of a user when playing golf. Of course, this display mechanism could also be used to display the score in a round of golf. The need to display three digits side by side, illustrated in a non-limiting manner, increases the perception of the footprint involved in such a display in the plane thereof. It is difficult in this case to define a satisfactory compromise between the footprint of the display and its legibility, more particularly if it is intended to be implemented in a wristwatch.

FIG. 1b illustrates a known alternative display mechanism implementing display members in the form of cylinders or rollers arranged so that their common axis of rotation is oriented in a direction parallel to the general plane of the corresponding timepiece movement (the support(s) for the bearings are not shown for the sake of simplicity). Considering that such a display mechanism is superposed on the standard thickness of the timepiece movement, it will be understood that the overall thickness of the corresponding timepiece is very large, particularly due to the large diameter of the units cylinder.

Other display mechanisms are also known that are intended to provide greater freedom of construction of the corresponding timepiece movements in terms of the footprint thereof. Patent application CH702422 describes for example an orbital current hour display mechanism that includes the features set out in the preamble. This mechanism comprises a support intended to be assembled on the plate of the corresponding timepiece movement so that it can rotate with reference to the centre of the timepiece movement. The support bears a sub-dial comprising a crown bearing hour graduations to display the current hour, together with an hour hand interacting with these graduations. The sub-dial and the hour hand are rotated so that they present a constant orientation with reference to the plate regardless of the position of the support with respect to the plate (that is, so that the 12 o'clock graduation is always positioned at midday in accordance with traditional timepiece reading convention). The hour hand is further driven, by a combined drive, to rotate with reference to the crown and display the current hour. The common axis of rotation of the crown and the hour hand is inclined outwards, with reference to a general plane of the plate, to free up space in the centre of the timepiece movement, so that other components can be positioned therein. The hour hand is flat and describes a disc when it makes a complete revolution around the sub-dial, the crown being inclined with respect to the plane of this disc, so that it is contained in a conical frustum the apex angle of which is preferably equal to the inclination angle of the axis of rotation of the sub-dial with respect to the general plane of the plate. Although this patent application states that the inclination angle can be greater than 15 degrees (while it is preferably less than this value), such an eventuality seems unrealistic in practice. Reading the current hour can be problematic in this case, in particular when the graduation of the crown corresponding to the hour to be indicated at a given instant is located towards the periphery of the timepiece movement, where the crown has a maximum inclination with reference to the general plane of the plate. Generally, it is in any case difficult to read the current hour with a significant inclination angle, as this takes place by reading the relative positions of the hour hand and the graduations of the crown, which are located in planes inclined with respect to each other. The benefit of this invention in terms of space saved in the centre of the timepiece movement thus appears limited by a necessary limitation of the inclination angle, without which the reading of the corresponding information becomes significantly degraded.

It therefore seems that for the time being, the watchmaker only has few options for producing a legible display having a footprint appropriate to their needs, in particular for taking into account the presence of any additional complications in the timepiece to be produced. If a watchmaker has to limit the footprint of such a display mechanism in the plane, he must accept a significant increase in overall thickness.

It could thus be useful for the watchmaker to have a new option at its disposal, different from the known structures, so as to have greater flexibility in the construction of a timepiece movement comprising a display mechanism of the type mentioned above.

### DISCLOSURE OF THE INVENTION

A main aim of the present invention is to propose a display mechanism for a timepiece movement providing an alternative presentation with reference to the known timepieces in terms of display, in particular good legibility obtained despite a smaller footprint in the plane than a disc display, and a smaller footprint in the direction of the thickness of the timepiece movement than a cylinder display.

Hence, the present invention more precisely relates to a display mechanism of the type set out above, the display surface of which can be driven so that it is situated substantially in a plane parallel to the general plane in the first position, at the predefined instant or when the predefined event occurs, in order to define a reading position, in which the conditions for the reading of the information by a user are optimal, the conditions for reading the information being degraded when the display surface is in the second position.

Furthermore, the display mechanism advantageously comprises an additional display member oriented so as to pivot about an additional axis of rotation having an inclination of between 10 and 80 degrees with reference to the general plane, and bearing at least one additional display surface intended to be rotated between at least two different positions about the additional axis of rotation, so that it is situated substantially in a plane parallel to the general plane in one position thereof, so as to define a reading position.

Finally, the present invention relates more particularly to such a display mechanism, characterized by the fact that the additional axis of rotation is substantially parallel to the axis of rotation of the first display member, and is arranged so that the reading position of the additional display surface is adjacent to the reading position of the first display surface.

Due to these features, the watchmaker can determine the best compromise, as a function of its own needs, with regard to the spatial distribution of the footprint of the display mechanism according to the invention, unlike in certain displays of the prior art. In addition, the display mechanism according to the invention proposes the reading of the absolute position of the display surface, and not the relative position, and the display surface must simply be situated in a plane parallel to the general plane of the plate, in the reading position, so that the reader can obtain the corresponding information. Compared with the structure in CH702422, the display surface bearing the 3 for example must simply be situated in the reading position for the user to know that it is 3 o'clock, in the case of an hour display. In the case of the display of another item of information such as par, the display surface corresponding to a setting made by the user, that is in response to the occurrence of a predefined event, is situated in the reading position. No other components are necessary to produce a display by reading the relative positions of two components of the display mechanism, as is the case of this prior structure. In addition, this reading position is very easily identified by the user as the reading conditions are optimal therein, whereas the conditions for reading the information borne by the display surface are significantly degraded when it is not in its reading position. A comparative examination of the different display surfaces visible (as some might potentially be concealed due to a very significant inclination with respect to the plane parallel to the general plane of the plate) makes it easy to identify the display surface that is in the reading position as being the one providing the best reading conditions, due to its substantially zero inclination angle with reference to the general plane of the plate.

Preferably, the display mechanism is arranged so that its display surface is situated in a plane secant to the general plane at least in its second position.

Of course, although the reading position is very easy to identify in the case of a jumping drive of the display mechanism, because the inclination of the display surface between its reading position and the adjacent positions varies more or less considerably (depending in particular on the number of display surfaces that the display member comprises, which influences the step between two successive positions), a margin of appreciation can be provided with respect to the parallelism of the display surface and the plate in the case of a dragging display. The conditions for reading the information borne by the display surface can be considered to remain optimal when the inclination of the display surface with reference to the parallel plane is within a range of plus or minus 15 degrees, preferably plus or minus 10 degrees. Of course, this margin of appreciation depends on the number of different display surfaces borne by the display member, and a person skilled in the art would have no particular difficulty adapting the present disclosure as a function of their own needs, without however departing from the scope of the invention defined by the appended claims.

In addition, provision can advantageously be made for the display member to bear at least two, preferably up to twelve, display surfaces.

In this case, provision can preferably be made for the display surfaces to be evenly distributed about the axis of rotation and arranged substantially about a conical frustum.

According to a preferred embodiment, provision can be made for the display member to bear a first toothed plate, preferably a first star, arranged about the axis of rotation and engaged with a second toothed plate, preferably a second star, oriented so that it is contained in a plane substantially parallel to the general plane, the second toothed plate having a kinematic link with a driving wheel intended to be driven by the timepiece movement or under the effect of a predefined action by a user on a control member.

In this case, provision can advantageously be made for the display mechanism to comprise a jumper for positioning the display member arranged to interact with the second toothed plate.

According to a preferred embodiment, provision can preferably be made for the display surface and the additional display surface to be arranged so that they are positioned adjacent to each other only when they are simultaneously in their respective reading positions.

In addition, provision can advantageously be made for the first display member to bear a stud arranged to actuate a star rigidly connected to the additional display member and move the star forward by at least one step on each complete revolution of the first display member. Provision can then preferably be made for this star to be rigidly connected to the additional display member so that it has an angular clearance with reference thereto, about the additional axis of rotation.

When the display mechanism comprises an additional display member, provision can be made for the additional axis of rotation to be separate from the first axis of rotation, the display mechanism comprising an additional support intended to be assembled at least indirectly on the plate and on which the additional display member is rotatably mounted. Provision can then be made for the support to bear a positioning member arranged to interact with an additional star, rigidly connected to the additional display member, to ensure the correct positioning of the additional display member with reference to the additional axis of rotation.

In general, provision can be made for the additional display member to bear at least two, preferably up to twelve, additional display surfaces.

The present invention also relates to a timepiece movement comprising a plate supporting a display mechanism according to the preceding features, as well as a timepiece comprising such a timepiece movement.

### BRIEF DESCRIPTION OF THE DRAWINGS

Further features and advantages of the present invention will become more clearly apparent on reading the following detailed description of a preferred embodiment, given with reference to the appended drawings given by way of non-limiting example, in which:

FIG. 1a shows a simplified front view of a display mechanism according to a first embodiment of the prior art, FIG. 1b shows a simplified perspective view of a display mechanism according to a second embodiment of the prior art, and FIG. 1c shows a simplified perspective view of a display mechanism according to a preferred embodiment of the present invention,

FIG. 2 shows a simplified partial perspective view of a structural detail of the display mechanism in FIG. 1c, and

FIG. 3 shows a simplified front view of part of a timepiece incorporating a display mechanism according to FIG. 1c.

### EMBODIMENT(S) OF THE INVENTION

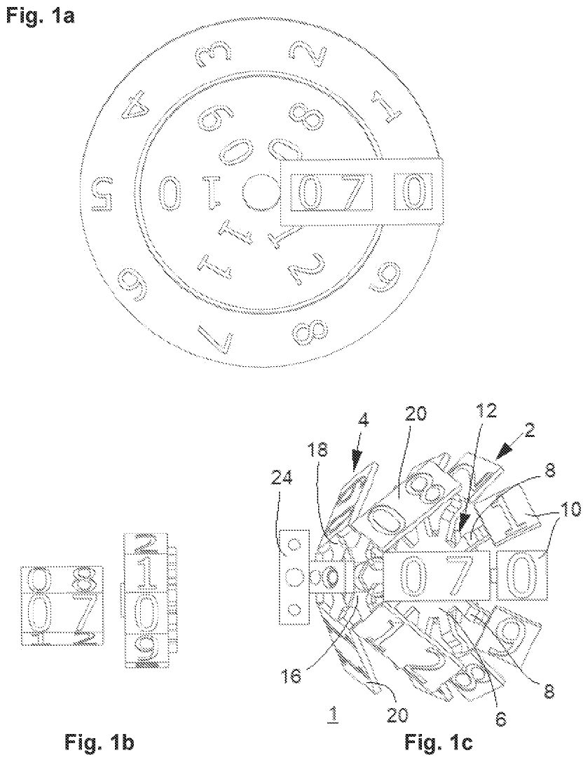

FIG. 1c shows a simplified perspective view of a display mechanism 1 according to a preferred embodiment of the present invention, making it possible to compare the respective footprints of the different prior art display mechanisms (FIGS. 1a and 1b) and of the display mechanism according to the present invention, for given display dimensions.

More specifically, the display mechanism 1 that can be seen in FIG. 1c is in this instance intended to display the par of a user in the context of playing golf, by way of non-limiting example.

To this end, the display mechanism 1 comprises a first units display member 2 associated with an additional tens and hundreds display member 4.

The units display member 2 comprises a hub 6 from which extend ten arms 8 evenly distributed about the hub 6 and each of which bears a pallet defining a display surface 10 for a digit between 0 and 9. The arms 8 and/or the display surfaces 10 have an inclination with reference to the mid-plane of the hub 6 so that the display surfaces 10 are distributed substantially about a conical frustum.

The teeth of a first toothed plate 12 can also be seen, in this instance the branches of a first star, coaxial with the hub 6 and rigidly connected thereto so as to rotate the display member 2 as will be described hereinafter.

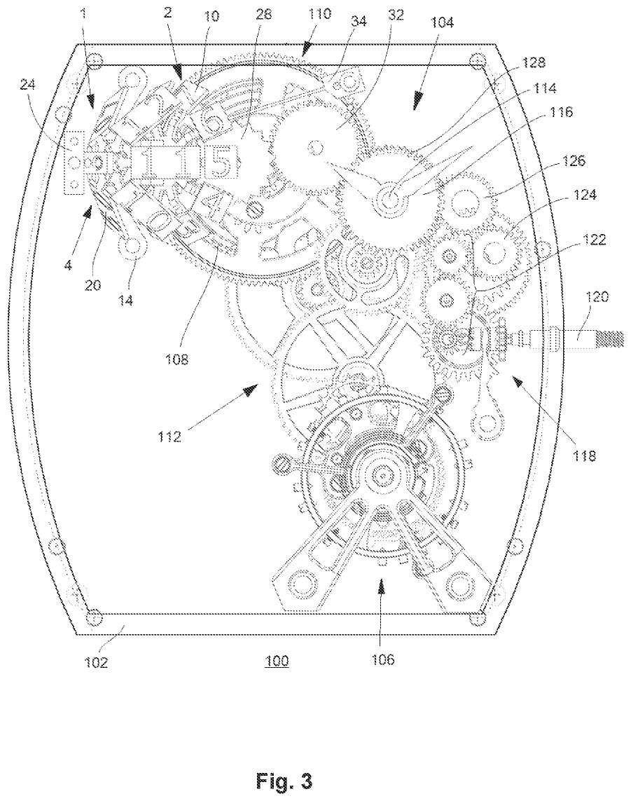

The display member 2 is intended to be rotatably mounted on a frame element of a timepiece movement, typically a plate, by means of a support (reference sign 14 in FIG. 3) having a bearing arranged so that the display member 2 is pivoted about an axis of rotation inclined with reference to a general plane of the plate of the timepiece movement, advantageously at an angle of between 10 and 80 degrees.

Due to its form and orientation, the display member 2 can present its display surfaces 10 in a reading position in turn. In other words, each display surface 10 has a plurality of different positions about the axis of rotation of the display member 2, one of these positions being such that the display surface 10 is situated in a plane substantially parallel to the general plane of the plate so as to define this reading position. In the view in FIG. 1c, the 0 is in this reading position. It is obvious that the reading conditions of the display surface situated in the reading position are optimal, in particular compared to the reading conditions of the other display surfaces that are not situated in the reading position, which are significantly degraded. Of course, the manner in which the reading conditions are degraded outside the reading position depends greatly on the number of display surfaces borne by the display member 2, the number of display surfaces having an impact on the relative inclination between two adjacent display surfaces.

Preferably, provision can advantageously be made for there to be just one reading position, the reading conditions being significantly degraded in all of the other positions, to prevent any doubt when reading the information displayed by the display member 2. Not only do the display surfaces situated in the positions adjacent to the reading position then have an inclination visible to the user, but some other positions potentially do not make it at all possible to read the information borne by the display surfaces in question.

The additional tens and hundreds display member 4 comprises a hub 16 from which extend six arms 18 evenly distributed about the hub 16 and each of which bears a pallet defining a display surface 20 for two digits, in this instance 07, 08, 09, 10, 11 and 12. The arms 18 and/or the display surfaces 20 have an inclination with reference to the mid-plane of the hub 16 so that the display surfaces 20 are distributed substantially about a conical frustum.

The additional display member 4 is also intended to be rotatably mounted on the plate of the timepiece movement by means of a support 24 having a bearing arranged so that the additional display member 4 is pivoted about an axis of rotation inclined with reference to the general plane of the plate, advantageously at an angle of between 10 and 80 degrees.

Due to its form and orientation, the additional display member 4 can thus also present its display surfaces 20 in a reading position in turn, this reading position being adjacent to the reading position of the display surfaces 10 of the units display member 2. In other words, each display surface 20 has a plurality of different positions about the axis of rotation of the additional display member 4, one of these positions being such that the display surface 20 is situated in a plane substantially parallel to the general plane of the plate so as to define this reading position. In the view in FIG. 1c, the 07 is in this reading position, and the value 070 can therefore be read by means of the two display surfaces 10, 20 situated in the two reading positions.

Preferably, the display surfaces 10 and the display surfaces 20 of the additional display member 4 are arranged so that they are positioned adjacent to each other only when they are simultaneously in their respective reading positions.

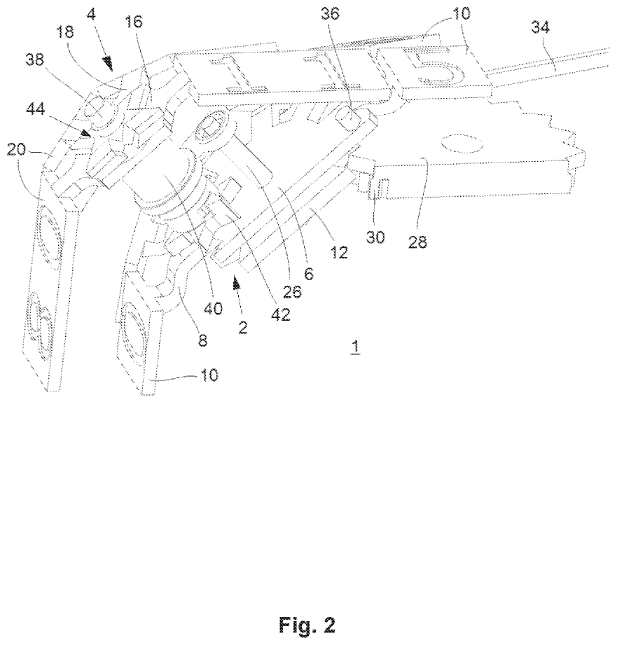

FIG. 2 shows a simplified partial perspective view of a structural detail of the display mechanism 1.

The units display member 2 comprises a pivot 26 housed in the bearing of the support 14 (not shown in FIG. 2 for greater clarity). Of course, a person skilled in the art could reverse the assembly of the display member 2 on the support 14 without departing from the scope of the invention as defined by the appended claims, that is, could provide for the support 14 to bear a fixed arbor about which is engaged a cannon rigidly connected to the display member 2.

The method for driving the display member 2 according to the present embodiment can be seen in FIG. 2. Provision can be made for the display mechanism 1 to comprise a second toothed plate 28, also a star in this instance, arranged engaged with the first toothed plate 12 of the display member 2.

Advantageously, the second toothed plate 28 is in this instance oriented so that it is contained in a plane substantially parallel to the general plane of the plate, and has a kinematic link, by means of a wheel 30 to which it is rigidly connected, with a driving wheel 32 intended to be driven by the timepiece movement or under the effect of a predefined action by a user on a control member.

A jumper 34 interacts with the second toothed plate 28 to ensure the required orientation of the display member 2 with reference to its axis of rotation, by means of the first and second toothed plates 12, 28.

In addition, the additional display member 4 is in this instance rotated directly by the units display member 2, by way of non-limiting illustration. To this end, the display member 2 comprises a stud 36, for driving the additional display member 4, rigidly connected to its hub 6 and intended to interact with the additional display member 4 once per complete revolution of the units display member 2.

The additional display member 4 also comprises a pivot 38 housed in the bearing of the support 24 (not shown in FIG. 2 for greater clarity). The hub 16 bears an arbor 40, oriented about the axis of rotation of the additional display member 4, at the end of which is arranged a star 42 intended to be driven by the stud 36 of the units display member 2 so as to pivot the additional display member 4 by one step on each complete revolution of the units display member 2.

Advantageously, provision can be made for the star 42 to be rigidly connected to the arbor 40 so as to have a given angular clearance to secure transmission between the two display members in both directions of rotation and avoid double jumps.

In addition, the support 24 advantageously bears a positioning member (not shown) arranged to interact with the branches of an additional star 44, rigidly connected to the hub 16, to ensure the correct positioning of the additional display member 4 with reference to its axis of rotation.

It can be seen in FIG. 2 that the respective axes of rotation of the two display members are parallel but offset, by way of non-limiting illustration, the display members being configured so that their display positions are adjacent.

Of course, as an alternative, provision can be made for the axes of rotation of the display members to be aligned, and for a single support to be implemented, either to bear both display members directly or to bear just one of them, which in turn bears the other.

FIG. 3 shows a simplified front view of part of a timepiece 100 incorporating the display mechanism 1 described above. The timepiece 100 comprises a case 102 housing a timepiece movement 104 the structure of which is of little importance for the implementation of the display mechanism according to the present invention.

The timepiece movement 104 will not therefore be described in detail for the sake of simplicity. The timepiece movement comprises a time base 106 the oscillations of which are maintained by a barrel spring 108, housed in a barrel 110, by means of a gear train 112, in the conventional manner. The gear train 112 is arranged to rotate members for displaying the current time by means of a cannon-pinion 114 and an hour wheel 116.

The timepiece movement 104 also comprises a winding and correction mechanism 118 actuated by a winding and correction stem 120 in this instance capable of occupying three different axial positions, one winding position and two correction positions. The winding and correction mechanism 118 comprises in particular a lever (not shown) bearing a set of correction setting wheels 122 the orientation of which depends on the axial position of the stem 120, so as to establish a kinematic link between the stem and a different mechanism to be corrected in each axial position. In one pulled-out axial position of the stem 120, the rotation thereof corrects the angular position of the current time display members, while in the other pulled-out axial position, the rotation of the stem 120 is transmitted to a first setting wheel 124. This setting wheel has a kinematic link with the driving wheel 32, in this instance comprising two additional setting wheels 126 and 128 (under the hour wheel 116), the driving wheel 32 being engaged with the units display member 2 by means of the second toothed plate 28 and the wheel 30.

Due to this structure, the rotation of the stem 120 in one direction or the other, when it is in its corresponding axial position, makes it possible to correct the par value displayed by the display mechanism 1, between the values of 070 and 129.

In FIG. 3, the display mechanism 1 has intentionally been positioned partially above the barrel 110 to better highlight the advantage of the present invention in terms of footprint. It will be noted the particular structure of the display mechanism 1 according to the invention makes it possible to install it in this case in the immediate vicinity of the barrel 110, which is generally the largest component of a timepiece movement, arranging the reading positions of the display members 2 and 4 above the barrel 110. Such an arrangement would not be possible with a cylinder display mechanism, while a legible disc display mechanism would occupy a significant portion of the available surface area in a plane parallel to the mid-plane of the timepiece movement (generally parallel to the general plane of the plate).

The display mechanism 1 is illustrated in this instance with axes of rotation of the display members 2 and 4 having the same inclination, of the order of 45 degrees, with respect to the general plane of the plate, but this is of course a non-limiting exemplary embodiment, and the inclination angle of each of the axes of rotation can vary between 10 and 80 degrees so as to take into account the specific features of the timepiece movement in which the display mechanism is installed. In this case, the display surfaces have an inclination of the order of 45 degrees with respect to the axis of rotation of the corresponding display member.

Due to the features disclosed above, a display mechanism is obtained providing the watchmaker with great flexibility to distribute the footprint thereof in a timepiece movement as a function of their needs, while providing excellent legibility.

Of course, although provision can be made for the display mechanism according to the invention to comprise an aperture or cover to facilitate the identification of the reading position, such a measure is only optional, as a comparative examination of the reading position and the other positions makes it possible to identify the reading position without any difficulty, due to a significant difference between their respective reading conditions. In this case, it is not a matter of solely assessing whether a given display surface is parallel or not to the general plane of the plate, but rather of preferably assessing the relative reading conditions between adjacent positions, which makes it possible to identify without any possible doubt which position corresponds to the reading position. It will also be noted that, even though it is not absolutely necessary (more particularly in the case of a dragging display), the identification of the reading position is simplified if the display surfaces are separate, as is the case of the preferred embodiment illustrated by way of non-limiting example.

The above description aims to describe a particular embodiment by way of non-limiting illustration, and the invention is not limited to the implementation of certain particular features described above. For example, the implementation of the present invention is not limited to the display of the quantity mentioned, that is, par when playing golf, and a person skilled in the art would have no particular difficulty adapting the present disclosure and producing a display mechanism containing the claimed features but implemented in relation to the display of another quantity, whether the display mechanism is driven by the timepiece movement or in response to an action by a user on a crown or on a pusher for example. The same applies to the structure of the mechanism for actuating the display mechanism as described and illustrated. By way of example, the first and second stars 12 and 28 could be replaced by toothed bevel gears. In addition, as mentioned above, when the display mechanism comprises a plurality of display members, each of them could be driven independently of the other(s), as an alternative to the illustrations and description above.

Finally, it will also be noted that, depending on the type of structure implemented, a person skilled in the art could produce a dragging display (for example the display of the seconds of time measured) or a jumping display as a function of their own needs.

1-13. (canceled)

14. A display mechanism for a timepiece movement comprising a plate defining a general plane,
the display mechanism comprising a support, intended to be assembled at least indirectly on the plate, and on which is rotatably mounted a display member bearing at least one display surface bearing at last one item of information to be displayed, associated with a predefined instant or a predefined event, said display surface being intended to be rotated between at least first and second different positions about the axis of rotation of said display member, so that it is situated substantially in a plane parallel to the general plane in said first position, at said predefined instant or when said predefined event occurs, so as to define a reading position of said information, in which the conditions for the reading of the information by a user are optimal, the conditions for reading said information being degraded when said display surface is in said at least second position,
said support being arranged so that said axis of rotation is oriented so as to have an inclination of between 10 and 80 degrees with reference to the general plane,
the display mechanism comprising an additional display member, oriented to pivot about an additional axis of rotation having an inclination of between 10 and 80 degrees with reference to the general plane, and bearing at least one additional display surface intended to be rotated between at least two different positions about said additional axis of rotation, so that it is situated substantially in a plane parallel to the general plane in one of its positions so as to define a reading position therein,
wherein said additional axis of rotation is substantially parallel to said axis of rotation, and is arranged so that the reading position of said additional display surface is adjacent to the reading position of said display surface.

15. The display mechanism of claim 14, further arranged so that said at least one display surface is situated in a plane secant to the general plane at least in said second position.

16. The display mechanism of claim 14, wherein said display member bears at least two, preferably up to twelve, display surfaces.

17. The display mechanism of claim 16, wherein said display surfaces are evenly distributed about said axis of rotation and arranged substantially about a conical frustum.

18. The display mechanism of claim 14, wherein said display member bears a first toothed plate arranged about the axis of rotation and engaged with a second, driving, toothed plate oriented so that it is contained in a plane substantially parallel to the general plane, said second toothed plate having a kinematic link with a driving wheel intended to be driven by the timepiece movement or under the effect of a predefined action by a user on a control member.

19. The display mechanism of claim 16, wherein said display member bears a first toothed plate arranged about the axis of rotation and engaged with a second, driving, toothed plate oriented so that it is contained in a plane substantially parallel to the general plane, said second toothed plate having a kinematic link with a driving wheel intended to be driven by the timepiece movement or under the effect of a predefined action by a user on a control member.

20. The display mechanism of claim 18, further comprising a jumper for positioning said display member arranged to interact with said second toothed plate.

21. The display mechanism of claim 14, wherein said display surface and said additional display surface are arranged so that they are positioned adjacent to each other only when they are simultaneously in their respective reading positions.

22. The display mechanism of claim 16, wherein said display surface and said additional display surface are arranged so that they are positioned adjacent to each other only when they are simultaneously in their respective reading positions.

23. The display mechanism of claim 14, wherein said display member bears a stud arranged to actuate a star rigidly connected to said additional display member and move the latter by at least one step on each complete revolution of said display member.

24. The display mechanism of claim 16, wherein said display member bears a stud arranged to actuate a star rigidly connected to said additional display member and move the latter by at least one step on each complete revolution of said display member.

25. The display mechanism of claim 23, wherein said star is rigidly connected to said additional display member so that it has an angular clearance with reference thereto, about said additional axis of rotation.

26. The display mechanism of claim 24, wherein said star is rigidly connected to said additional display member so that it has an angular clearance with reference thereto, about said additional axis of rotation.

27. The display mechanism of claim 14, wherein said additional axis of rotation is separate from said axis of rotation, the display mechanism comprising an additional support intended to be assembled at least indirectly on the plate and on which the additional display member is rotatably mounted.

28. The display mechanism of claim 16, wherein said additional axis of rotation is separate from said axis of rotation, the display mechanism comprising an additional support intended to be assembled at least indirectly on the plate and on which the additional display member is rotatably mounted.

29. The display mechanism of claim 27, wherein said support bears a positioning member arranged to interact with an additional star, rigidly connected to said additional display member, to ensure the correct positioning of said additional display member with reference to said additional axis of rotation.

30. The display mechanism of claim 28, wherein said support bears a positioning member arranged to interact with an additional star, rigidly connected to said additional display member, to ensure the correct positioning of said additional display member with reference to said additional axis of rotation.

31. The display mechanism of claim 14, wherein said additional display member bears at least two, preferably up to twelve, additional display surfaces.

32. A timepiece movement comprising a plate supporting the display mechanism according to claim 14.

33. A timepiece movement comprising a plate supporting the display mechanism according to claim 16.

34. A timepiece movement comprising a plate supporting the display mechanism according to claim 17.

35. A timepiece movement comprising a plate supporting the display mechanism according to claim 19.

36. A timepiece movement comprising a plate supporting the display mechanism according to claim 20.

37. A timepiece movement comprising a plate supporting the display mechanism according to claim 22.

38. A timepiece movement comprising a plate supporting the display mechanism according to claim 23.

39. A timepiece comprising a timepiece movement comprising the display supporting a display mechanism according to claim 14.

40. A timepiece comprising a timepiece movement comprising a plate supporting the display mechanism according to claim 16.

41. A timepiece comprising a timepiece movement comprising a plate supporting the display mechanism according to claim 19.

42. A timepiece comprising a timepiece movement comprising a plate supporting the display mechanism according to claim 20.

43. A timepiece comprising a timepiece movement comprising a plate supporting the display mechanism according to claim 23.
